(19) United States
(12) Patent Application Publication
(10) Pub. No.: US 2026/0001299 A1
(43) Pub. Date: Jan. 1, 2026

(54) COVERING MATERIAL, INTERIOR MATERIAL, AND METHOD FOR PRODUCING INTERIOR MATERIAL

(71) Applicant: TOKAI CHEMICAL INDUSTRIES, LTD., Gifu (JP)

(72) Inventors: Takahiro Kawada, Gifu (JP); Yukihiro Sakashita, Gifu (JP); Hiroshi Koide, Gifu (JP); Yasuo Suzuki, Gifu (JP)

(73) Assignee: TOKAI CHEMICAL INDUSTRIES, LTD., Gifu (JP)

(21) Appl. No.: 19/318,394

(22) Filed: Sep. 4, 2025

Related U.S. Application Data
(63) Continuation of application No. PCT/JP2024/008118, filed on Mar. 4, 2024.

(30) Foreign Application Priority Data
Mar. 10, 2023 (JP) 2023-037973

(51) Int. Cl. B32B 3/30; B32B 3/06; B32B 3/26; B32B 38/00

(52) U.S. Cl. CPC B32B 3/30; B32B 3/06; B32B 3/266; B32B 38/0012; B32B 2038/008; B32B 2307/7375; B32B 2451/00

(57) ABSTRACT

An interior material is composed of: a covering material formed of a resin material and having a front surface which is a design surface and a back surface which is a fixed surface; and a base material to which the fixed surface of the covering material is fixed. An outer stitch is formed on the design surface of the covering material. A protrusion is formed along the outer stitch on the fixed surface. A hole with which the protrusion is engageable is formed at the base material. The covering material is fixed to the base material by engaging the protrusion with the hole.

### CROSS-REFERENCE TO RELATED APPLICATION

The present application is a continuation of PCT/JP2024/008118, filed on Mar. 4, 2024, and is related to and claims priority from Japanese patent application no. 2023-037973, filed on Mar. 10, 2023. The entire contents of the aforementioned application are hereby incorporated by reference herein.

### BACKGROUND

### Technical Field

The disclosure relates to: a covering material that has a stitching pattern applied to the front surface thereof using methods such as sewing and is fixed to a base material to be used as, for example, an interior material of an automobile; an interior material formed by fixing the covering material to a base material; and a production method for fixing the covering material to the base material to produce the interior material.

### Related Art

For example, as disclosed in Patent Document 1 (Japanese Patent No. 4933260), in an interior material of an automobile, a stitching pattern is applied to the front surface by sewing or the like to improve design properties. In that case, the interior material is formed by separately producing a base material and a covering material with a stitching pattern applied thereon, and fixing the covering material to the front surface of the base material.

FIG. 9 shows a part of an interior material 40 on which an outer stitch 48, which is a stitching pattern, appears along a corner part 41. FIG. 10 shows an enlarged cross-section perpendicular to the corner part 41.

The interior material 40 is composed of a base material 42 having an inner corner part 43 matching the corner part 41, and a covering material 44 fixed to the front surface of the base material 42. The covering material 44 is divided into a lower covering 45 and an upper covering 46. Furthermore, a folded end 47 of the upper covering 46 is overlapped with the upper end of the lower covering 45, which are sewn with an outer stitch 48 and an inner stitch 49. A matching groove 50 is formed on the front surface of the inner corner part 43 to position the sewn portion between the lower covering 45 and the upper covering 46.

Thus, when fixing the covering material 44, an adhesive is applied to the matching groove 50 and the inner surface of the upper end of the lower covering 45, and the outer stitch 48 is matched with the matching groove 50 by visually checking and adhered. Afterward, by adhering the outer periphery of the covering material 44 in a state folded to the back side of the base material 42, an interior material 40 with the covering material 44 fixed to the base material 42 is obtained.

The conventional covering material 44 described above is adhered by matching the positions of the outer stitch 48 and the matching groove 50 by visually checking. Thus, positioning of the outer stitch 48 is difficult, and if the outer stitch 48 is misaligned or meanders, re-adhesion becomes necessary. Accordingly, the fixing work takes more time.

### SUMMARY

A first configuration of the disclosure is a covering material, formed of a resin material and having a front surface which is a design surface and a back surface which is a fixed surface, the fixed surface being fixed to a base material. The design surface is formed with a specific stitching pattern. The fixed surface is formed with a protrusion or a recess along the stitching pattern. The covering material is capable of being fixed to the base material by engaging the protrusion or the recess with an engaged part formed at the base material.

According to another aspect of the first configuration, in the above configuration, multiple protrusions or recesses are configured at specific intervals in a specific first direction.

According to another aspect of the first configuration, in the above configuration, the protrusion or the recess includes a projecting protrusion or a projecting recess that projects in a second direction intersecting with the first direction.

According to another aspect of the first configuration, in the above configuration, the protrusion or the recess extends in a specific first direction and includes multiple projecting protrusions or projecting recesses that project in a second direction intersecting with the first direction at specific intervals in the first direction.

According to another aspect of the first configuration, in the above configuration, the protrusion or the recess includes a first protrusion or a first recess and a second protrusion or a second recess configured alternately and continuously in a specific first direction, and the first protrusion or the first recess and the second protrusion or the second recess have widths different from each other in a second direction perpendicular to the first direction.

According to another aspect of the first configuration, in the above configuration, the protrusion or the recess includes first protrusions or first recesses and second protrusions or second recesses configured alternately at specific intervals in a specific first direction, and each of the first protrusions or each of the first recesses and each of the second protrusions or each of the second recesses are configured to be separated in a second direction perpendicular to the first direction.

According to another aspect of the first configuration, in the above configuration, each of the first protrusions or each of the first recesses and each of the second protrusions or each of the second recesses have a same shape.

According to another aspect of the first configuration, in the above configuration, each of the first protrusions or each of the first recesses and each of the second protrusions or each of the second recesses have widths different from each other in the second direction.

According to another aspect of the first configuration, in the above configuration, the stitching pattern is formed by sewing.

According to another aspect of the first configuration, in the above configuration, the design surface is formed with a sewing guide line configured parallel to the protrusion or the recess.

According to another aspect of the first configuration, in the above configuration, the stitching pattern is formed by texture molding.

A second configuration of the disclosure is an interior material composed of: a covering material formed of a resin material and having a front surface which is a design surface and a back surface which is a fixed surface; and a base material to which the fixed surface of the covering material is fixed. The design surface of the covering material is formed with a specific stitching pattern, and the fixed surface is formed with a protrusion or a recess along the stitching pattern. The base material is formed with an engaged part with which the protrusion or the recess is engageable. The covering material is fixed to the base material by engaging the protrusion or the recess with the engaged part.

A third configuration of the disclosure is a method for producing an interior material, which is a method of producing an interior material by fixing a covering material to a base material, the covering material being formed of a resin material and having a front surface which is a design surface and a back surface which is a fixed surface. The method for producing an interior material includes: a process of forming a specific stitching pattern on the design surface of the covering material and forming a protrusion or a recess along the stitching pattern on the fixed surface; a process of forming, at the base material, an engaged part with which the protrusion or the recess is engageable; and a process of engaging the protrusion or the recess with the engaged part to fix the covering material to the base material.

According to the disclosure, without visually checking the stitching pattern, by simply engaging the protrusion or the recess with the engaged part, the stitching pattern can be easily positioned at the appropriate position with respect to the base material. Thus, workability related to fixing to the base material is excellent. In addition, since an adhesive is not required at the portion of the stitching pattern, the work hour related to production of the interior material is reduced. Also, separation of the covering material from the base material at the time of discarding, for example, can be easily performed.

According to another aspect of the first configuration, the protrusions or the recesses are configured at specific intervals in the specific first direction. Thus, in addition to the above effects, the portion of the stitching pattern is positioned at several sites, and misalignment of the stitching pattern is suppressed. In addition, integration between the covering material and the base material is enhanced.

According to another aspect of the first configuration, the protrusion or the recess includes the projecting protrusion or the projecting recess. In addition, the first protrusion or the first recess and the second protrusion or the second recess are provided with different widths in the second direction. Furthermore, multiple first protrusions or first recesses and multiple second protrusions or second recesses are configured to be separated in the second direction. Thus, in addition to the above effects, misalignment of the covering material is effectively prevented, and integration in the engaged state between the covering material and the base material is further enhanced.

According to another aspect of the first configuration, in addition to the above effects, by forming the stitching pattern by sewing, a design surface with high design property is obtained.

According to another aspect of the first configuration, the sewing guide line configured parallel to the protrusion or the recess is formed on the design surface. Thus, in addition to the above effects, the sewing guide line serves as a guide for the sewing position, and it becomes easy to apply the stitching pattern.

According to another aspect of the first configuration, in addition to the above effects, since the stitching pattern is formed by texture molding, the stitching pattern can be easily formed.

### BRIEF DESCRIPTION OF THE DRAWINGS

FIG. 1 is a perspective view showing a part of an interior material.

FIG. 2 is an enlarged view showing a cross-section perpendicular to a corner part of the interior material.

FIG. 3A and FIG. 3B are views illustrating the covering material. FIG. 3A is a side view viewed from a D2 direction, and FIG. 3B is an enlarged cross-sectional view taken along a line A-A.

FIG. 4 is a perspective view showing a part of a base material.

FIG. 5 is a view illustrating a modification example of a protrusion.

FIG. 6 is a view illustrating a modification example of the protrusion.

FIG. 7 is a view illustrating a modification example of the protrusion.

FIG. 8 is a view illustrating a modification example of the protrusion.

FIG. 9 is a perspective view showing a part of a conventional interior material.

FIG. 10 is an enlarged view showing a cross-section perpendicular to a corner part of the conventional interior material.

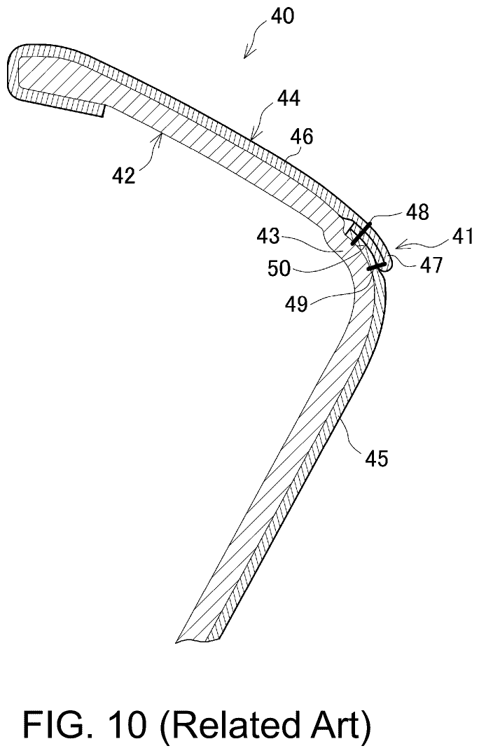

### DESCRIPTION OF THE EMBODIMENTS

Embodiments of the disclosure provide a covering material, an interior material, and a method for producing an interior material that are capable of easily positioning a stitching pattern such as an outer stitch applied to a design surface with respect to a base material and are excellent in workability related to fixing to the base material.

Hereinafter, an embodiment of the disclosure will be described based on the drawings.

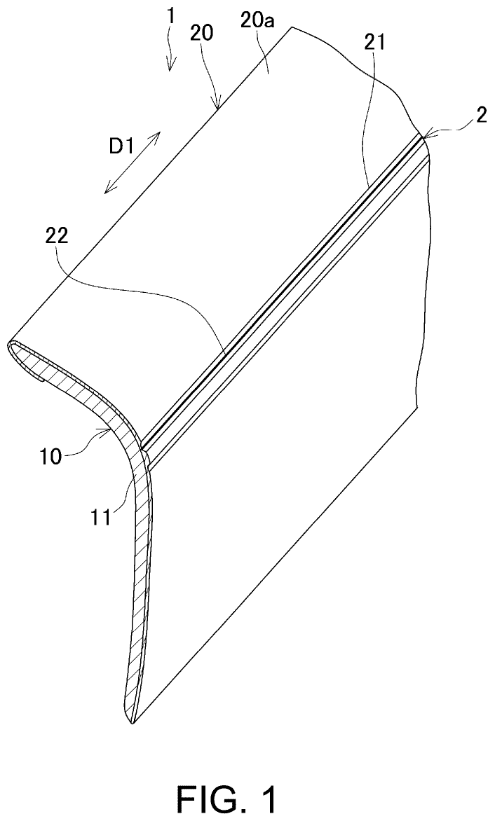

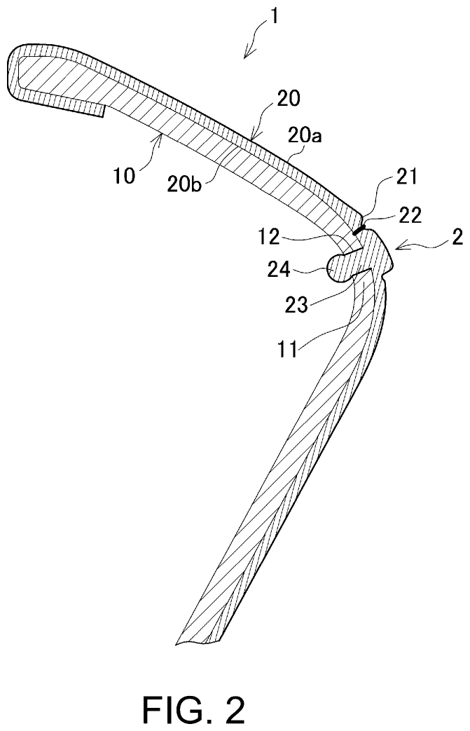

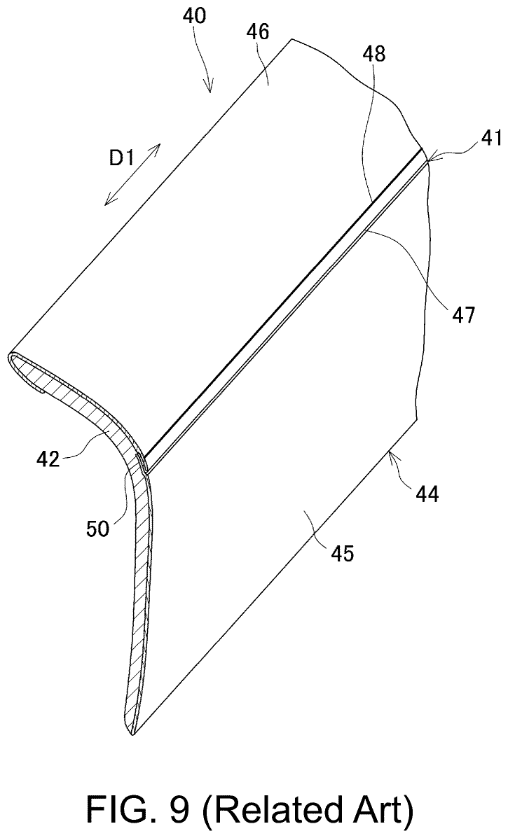

Similar to FIG. 9, FIG. 1 shows a part of an interior material 1 for an automobile on which an outer stitch 22 appears along a corner part 2. FIG. 2 shows an enlarged cross-section perpendicular to the corner part 2.

The interior material 1 is composed of a base material 10 and a covering material 20 fixed to the front surface of the base material 10.

The covering material 20 is produced by injection molding such as RIM with a resin material such as urethane. The covering material 20 has a sheet shape with the front surface being a design surface 20a and the back surface being a fixed surface 20b. On the design surface 20a, at the position corresponding to the corner part 2, a groove-shaped sewing guide line 21 is formed straight in a D1 direction in which the corner part 2 extends. The outer stitch 22 is applied parallel to the D1 direction at the bottom of the sewing guide line 21. The outer stitch 22 is applied to the sewing guide line 21 after injection molding of the covering material 20.

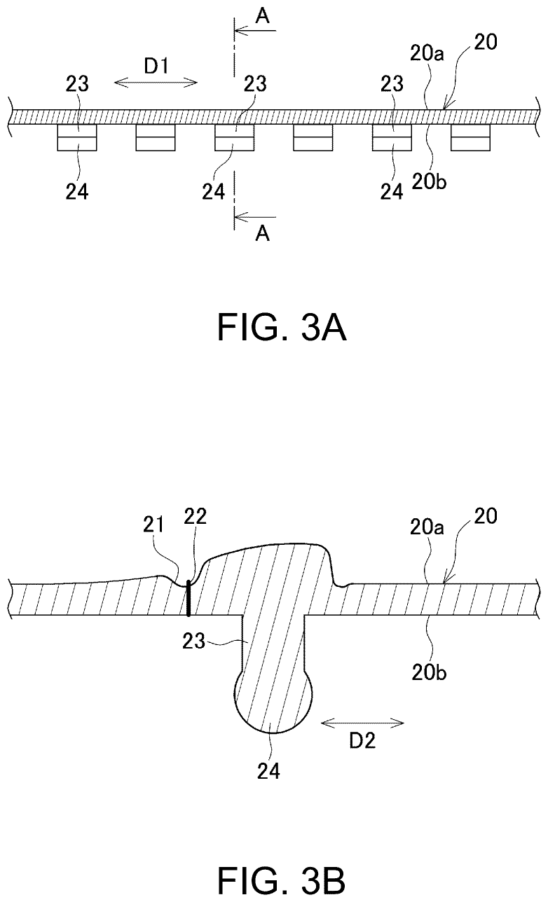

As also shown in FIG. 3A, multiple protrusions 23, 23 . . . are formed protruding on the fixed surface 20b of the covering material 20. Each protrusion 23 is configured straight in the D1 direction at specific intervals. The configuration position is a position slightly shifted from the outer stitch 22. Each protrusion 23 has a rectangular shape in a plan view in which the length in the D1 direction is greater than the length (width) in a D2 direction perpendicular to the D1 direction in the surface direction of the covering material 20 in a planar state as shown in FIG. 3B. A retaining part 24 in a round rod shape with a width larger than the base side is integrally formed at the protruding end of each protrusion 23.

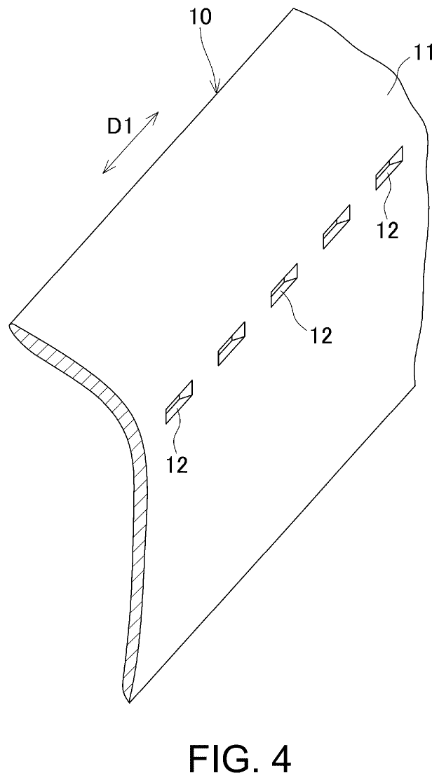

The base material 10 is produced by injection molding with a resin material such as PP or ABS, and as shown in FIG. 4, includes an inner corner part 11 matching the corner part 2. Multiple holes 12, 12 . . . in the same number as the protrusions 23 of the covering material 20 are formed in the inner corner part 11. Each hole 12 penetrates in the thickness direction through the base material 10 and is configured straight in the D1 direction at the same intervals as the protrusions 23 of the covering material 20.

Each hole 12 is formed slightly larger than the length and the width of the protrusion 23 excluding the retaining part 24, and is formed slightly smaller than the width of the retaining part 24.

When fixing the covering material 20 produced as described above to the base material 10, as shown in FIG. 2, each protrusion 23 of the covering material 20 is sequentially inserted into each hole 12 of the base material 10. Then, the retaining part 24 causes the hole 12 to elastically deform to allow the protrusion 23 to pass through, and the retaining part 24 turns into a state protruding from the back surface of the base material 10. Thus, upon inserting all protrusions 23 into the holes 12, the covering material 20 is fixed by engagement between each protrusion 23 and each hole 12. In this fixed state, the outer stitch 22 appears straight in the D1 direction without meandering.

Then, upon folding back the outer periphery of the covering material 20 at the end of the base material 10 and adhering to the base material 10, an interior material 1 with the covering material 20 fixed to the front surface of the base material 10 is obtained.

In this manner, in the covering material 20 of the above embodiment, the outer stitch 22 as an example of a stitching pattern is formed on the design surface 20a, and the multiple protrusions 23 are formed along the outer stitch 22 on the fixed surface 20b. Thus, it is possible to fix to the base material 10 by engaging the protrusions 23 with the holes 12 serving as an example of an engaged part formed in the base material 10.

According to this configuration, without visually checking the outer stitch 22, by simply engaging the protrusions 23 with the holes 12, the outer stitch 22 can be easily positioned at the appropriate position with respect to the base material 10. Thus, workability related to fixing to the base material 10 is excellent. In addition, since an adhesive is not required at the portion of the outer stitch 22, the work hour related to production of the interior material 1 is reduced. Also, separation of the covering material 20 from the base material 10 at the time of discarding, for example, can be easily performed.

Multiple protrusions 23 are configured at specific intervals in the D1 direction as an example of a first direction.

Thus, the portion of the outer stitch 22 is positioned at several sites, and misalignment of the outer stitch 22 is suppressed. In addition, integration between the covering material 20 and the base material 10 is further enhanced.

The stitching pattern is formed by the outer stitch 22.

Thus, a design surface 20a with high design effect is obtained.

The sewing guide line 21 configured parallel to the protrusions 23 is formed on the design surface 20a.

Thus, the sewing guide line 21 serves as a guide for the position of the outer stitch 22, and it becomes easy to apply the outer stitch 22.

In this manner, the interior material 1 of the above embodiment is composed of: the covering material 20 formed of a resin material and having the front surface being the design surface 20a and the back surface being the fixed surface 20b; and the base material 10 to which the fixed surface 20b of the covering material 20 is fixed. The outer stitch 22 is formed on the design surface 20a of the covering material 20, the protrusions 23 are formed along the outer stitch 22 on the fixed surface 20b, and the holes 12 with which the protrusions 23 are engageable are formed in the base material 10. The covering material 20 is fixed to the base material 10 by engaging the protrusions 23 with the holes 12.

In addition, the method for producing the interior material 1 of the above embodiment executes: a process of forming the outer stitch 22 on the design surface 20a of the covering material 20 and forming the protrusions 23 along the outer stitch 22 on the fixed surface 20b; a process of forming, in the base material 10, the holes 12 with which the protrusions 23 are engageable; and a process of engaging the protrusions 23 with the holes 12 to fix the covering material 20 to the base material 10.

In the interior material 1 and the production method thereof as well, without visually checking the outer stitch 22, by simply engaging the protrusions 23 with the holes 12, the outer stitch 22 can be easily positioned at the appropriate position with respect to the base material 10. Thus, workability related to fixing the covering material 20 to the base material 10 is excellent. In addition, since an adhesive is not required at the portion of the outer stitch 22, the work hour related to production of the interior material 1 is reduced. Also, separation of the covering material 20 from the base material 10 at the time of discarding, for example, can be easily performed.

Hereinafter, modification examples of the disclosure will be described.

The shape of the protrusion provided at the covering material may be appropriately modified from the above configuration. The retaining part is not limited to the round rod shape as in the above embodiment, but may also be, for example, configured in an arrowhead shape with a barb. The retaining part may also be omitted.

The protrusion may be configured to have a length in the D1 direction that is shorter or longer than in the above embodiment.

The protrusion may be configured to have a protruding length from the fixed surface that is longer than in the above embodiment.

The protrusion is not limited to a rectangular shape in a plan view as in the above embodiment, but may also be in another plan view shape such as a circular shape in a plan view or a cross shape in a plan view.

The engaged part provided at the base material is formed to match the protrusion. The engaged part is not limited to the hole in the above embodiment, but may also be a recess.

Hereinafter, modification examples of the protrusion will be specifically listed.

Although not specifically described, in accordance with the change in the shape of the protrusion, the hole or the recess provided at the base material also has a shape that is engaged with the protrusion of the modification example.

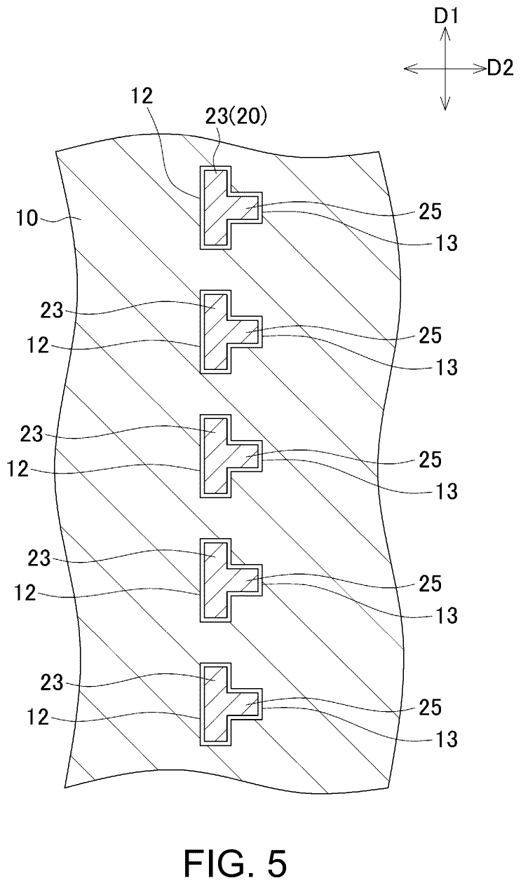

FIG. 5 shows an example in which a projecting protrusion 25 projecting in the D2 direction is integrally formed on the lateral surface of the protrusion 23 to form a T-shape in a plan view. Thus, each hole 12 of the base material 10 also has a T-shape in a plan view with a projecting hole 13 connected corresponding to the projecting protrusion 25. FIG. 5 shows an enlarged cross-section in the surface direction of the base material 10 at the portion at which each protrusion 23 and each projecting protrusion 25 are engaged with each hole 12 and each projecting hole 13, respectively. The same applies to the following modification examples.

In this manner, the projecting protrusion 25 projecting in the D2 direction, which serves as an example of a second direction perpendicular to the D1 direction, is provided at the protrusion 23. Thus, misalignment of the covering material 20 is effectively prevented, and integration in the engaged state between the covering material 20 and the base material 10 is further enhanced.

The projecting direction of the projecting protrusion 25 is not limited to the perpendicular D2 direction as long as it is a direction intersecting with the D1 direction, and the projecting direction may also be a direction inclined with respect to the D1 direction. This also applies to other modification examples that include the projecting protrusion 25. In addition, the projecting direction of the projecting protrusion 25 may also be reversed from the example in FIG. 5, or may also project alternately for each protrusion 23.

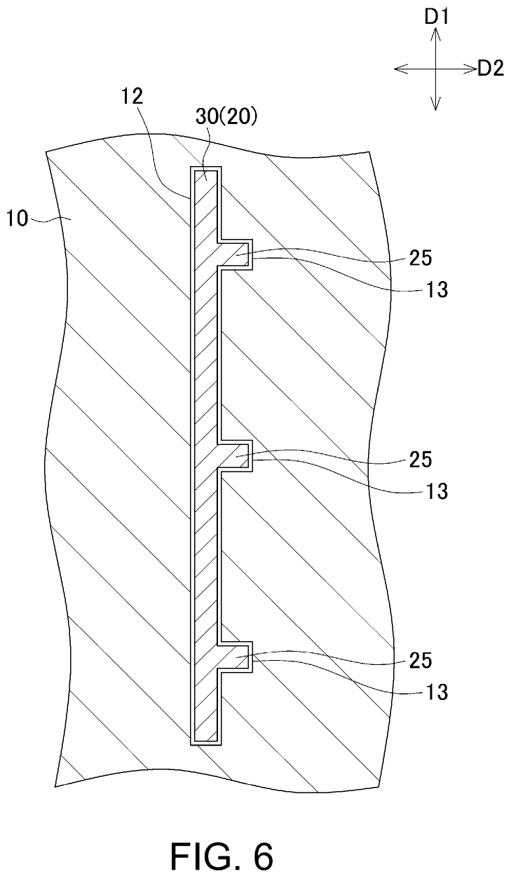

FIG. 6 shows an example in which the protrusion is configured as a plate-shaped protrusion 30 that extends longer in the D1 direction than in the above embodiment. Projecting protrusions 25 which are the same as in FIG. 5 are integrally formed at multiple sites at specific intervals in the D1 direction on the lateral surface of the plate-shaped protrusion 30.

In this manner, the protrusion is configured as the plate-shaped protrusion 30 extending in the D1 direction, and multiple projecting protrusions 25 projecting in the D2 direction perpendicular to the D1 direction are included at specific intervals in the D1 direction. In this case as well, misalignment of the covering material 20 is effectively prevented, and integration in the engaged state between the covering material 20 and the base material 10 is further enhanced.

In FIG. 6 as well, the projecting direction of the projecting protrusion 25 may also be reversed. In addition, the projecting protrusions 25 may also be configured to project alternately with the plate-shaped protrusion 30 interposed therebetween.

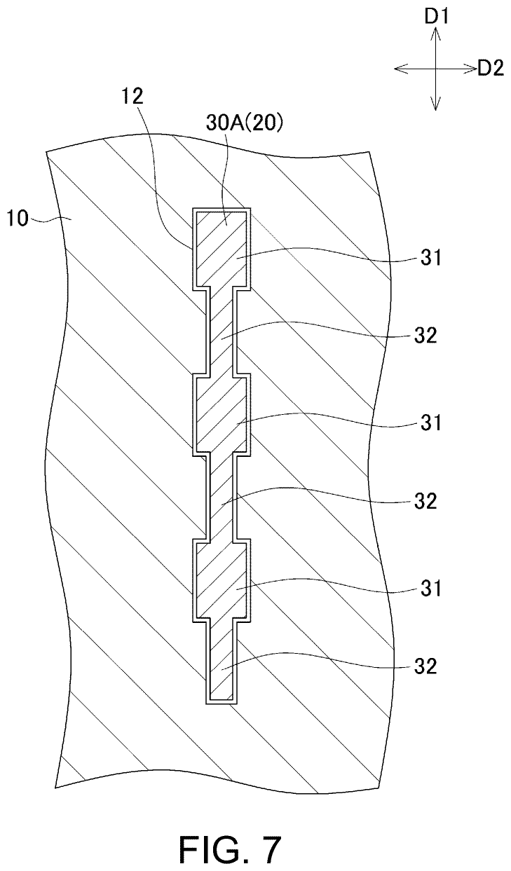

FIG. 7 shows an example in which the protrusion is configured as a plate-shaped protrusion 30A that extends in the D1 direction, and the plate-shaped protrusion 30A has a shape in which multiple first protrusions 31 and multiple second protrusions 32 with widths different from each other in the D2 direction are configured alternately and continuously.

In this manner, the protrusion is configured as the plate-shaped protrusion 30A including the first protrusions 31 and the second protrusions 32 configured alternately and continuously in the D1 direction, and the widths of the first protrusions 31 and the second protrusions 32 in the D2 direction are configured to be different from each other. In this case as well, misalignment of the covering material 20 is effectively prevented, and integration in the engaged state between the covering material 20 and the base material 10 is further enhanced.

In FIG. 7, the first protrusion 31 and the second protrusion 32 are configured such that centers of the widths thereof in the D2 direction are aligned on a straight line in the D1 direction, but the first protrusion 31 and the second protrusion 32 may also be configured such that the centers thereof shift from each other. The centers may shift alternately or randomly.

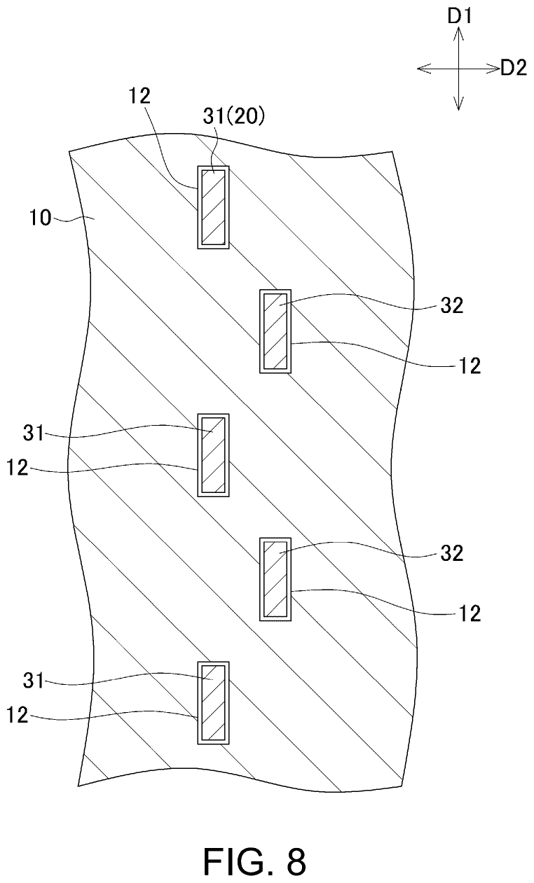

FIG. 8 shows an example in which the first protrusion 31 and the second protrusion 32 have the same shape, are separated in the D1 direction, and are configured to shift alternately in the D2 direction.

In this manner, the protrusions include the first protrusions 31 and the second protrusions 32 configured alternately at specific intervals in the D1 direction, and the first protrusion 31 and the second protrusion 32 are configured to be separated in the D2 direction. In this case as well, misalignment of the covering material 20 is effectively prevented, and integration in the engaged state between the covering material 20 and the base material 10 is further enhanced.

The widths of the first protrusion 31 and the second protrusion 32 in the D2 direction may also be configured to be different from each other as shown in FIG. 7.

In the above embodiment and each modification example, the protrusion is formed at the covering material, and the hole or the recess is formed at the base material. However, the configuration may also be reversed to provide the protrusion on the front surface of the base material, and form the recess, with which the protrusion engages, on the fixed surface of the covering material.

In the above embodiment and each modification example, the form of the outer stitch may be appropriately changed. However, the stitching pattern is not limited to stitching such as the outer stitch. The stitching pattern may also be formed, for example, by texture molding (texture processing), or may also be printed on the design surface. In any case, the stitching pattern may be easily formed simultaneously with the molding of the covering material.

The stitching pattern may also be multiple lines.

The sewing guide line is not limited to the groove shape in the above embodiment, but may also be in a line shape. The sewing guide line may also be omitted.

The shapes of the covering material and the base material may also be appropriately changed. The disclosure may be applied even to cases where the stitching pattern appears by methods such as stitching on a planar part rather than a corner part of the interior material.

What is claimed is:

1. A covering material, formed of a resin material and having a front surface which is a design surface and a back surface which is a fixed surface, the fixed surface being fixed to a base material, wherein
the design surface is formed with a specific stitching pattern,
the fixed surface is formed with a protrusion or a recess along the stitching pattern, and
the covering material is capable of being fixed to the base material by engaging the protrusion or the recess with an engaged part formed at the base material.

2. The covering material according to claim 1, wherein a plurality of the protrusions or the recesses are configured at specific intervals in a specific first direction.

3. The covering material according to claim 2, wherein the protrusion or the recess comprises a projecting protrusion or a projecting recess that projects in a second direction intersecting with the first direction.

4. The covering material according to claim 1, wherein the protrusion or the recess extends in a specific first direction and comprises a plurality of projecting protrusions or projecting recesses that project in a second direction intersecting with the first direction at specific intervals in the first direction.

5. The covering material according to claim 1, wherein the protrusion or the recess comprises a first protrusion or a first recess and a second protrusion or a second recess configured alternately and continuously in a specific first direction, and the first protrusion or the first recess and the second protrusion or the second recess have widths different from each other in a second direction perpendicular to the first direction.

6. The covering material according to claim 1, wherein the protrusion or the recess comprises first protrusions or first recesses and second protrusions or second recesses configured alternately at specific intervals in a specific first direction, and each of the first protrusions or each of the first recesses and each of the second protrusions or each of the second recesses are configured to be separated in a second direction perpendicular to the first direction.

7. The covering material according to claim 6, wherein each of the first protrusions or each of the first recesses and each of the second protrusions or each of the second recesses have a same shape.

8. The covering material according to claim 6, wherein each of the first protrusions or each of the first recesses and each of the second protrusions or each of the second recesses have widths different from each other in the second direction.

9. The covering material according to claim 1, wherein the stitching pattern is formed by sewing.

10. The covering material according to claim 9, wherein the design surface is formed with a sewing guide line configured parallel to the protrusion or the recess.

11. The covering material according to claim 1, wherein the stitching pattern is formed by texture molding.

12. An interior material composed of:
a covering material formed of a resin material and having a front surface which is a design surface and a back surface which is a fixed surface; and
a base material to which the fixed surface of the covering material is fixed, wherein
the design surface of the covering material is formed with a specific stitching pattern, and the fixed surface is formed with a protrusion or a recess along the stitching pattern,
the base material is formed with an engaged part with which the protrusion or the recess is engageable, and
the covering material is fixed to the base material by engaging the protrusion or the recess with the engaged part.

13. A method for producing an interior material, which is a method of producing an interior material by fixing a covering material to a base material, the covering material being formed of a resin material and having a front surface which is a design surface and a back surface which is a fixed surface, the method for producing an interior material comprising:
forming a specific stitching pattern on the design surface of the covering material and forming a protrusion or a recess along the stitching pattern on the fixed surface;
forming, at the base material, an engaged part with which the protrusion or the recess is engageable; and
engaging the protrusion or the recess with the engaged part to fix the covering material to the base material.
